(19) United States
(12) Patent Application Publication
(10) Pub. No.: US 2026/0228114 A1
(43) Pub. Date: Aug. 6, 2026

(54) System and Method for Automated Test Case Generation

(71) Applicant: The Toronto-Dominion Bank, Toronto (CA)

(72) Inventor: Shishu Pal KUMAR, Etobicoke (CA)

(73) Assignee: The Toronto-Dominion Bank, Toronto, ON (CA)

(21) Appl. No.: 19/043,877

(22) Filed: Feb. 3, 2025

(51) Int. Cl. G06F 11/3668

(52) U.S. Cl. CPC G06F 11/3684

(57) ABSTRACT

System and method for automated test case generation. The method includes obtaining an application programming interface (API) specification and using the API specification to generate a plurality of test requests, each test request corresponding to an API endpoint associated with an application. The method also includes generating a plurality of test scenarios based on technical parameters of the API endpoints, and utilizing the plurality of test requests and test scenarios in a process associated with the application.

### TECHNICAL FIELD

The following generally relates to test case generation and execution and, in particular, to automated test case generation using predefined specifications.

### BACKGROUND

Manually generating test cases, e.g., for application programming interface (API) testing, can be a tedious and time-consuming process. There are two parts of API testing, one which involves testing an API's process functionality and the other which involves testing technical boundaries and other requirements of the API. The latter category mainly involves validating the details of the API such as required fields, data types, enumeration, data boundary values and value restrictions as well as its adherence to API specifications, API requirement terms, etc.

### BRIEF DESCRIPTION OF THE DRAWINGS

Embodiments will now be described with reference to the appended drawings wherein:

FIG. 1 is a schematic diagram of an example computing environment.

FIG. 2 is a block diagram of an example configuration of an application development environment.

FIG. 3 is a block diagram of an example configuration of an application testing environment.

FIG. 4 illustrates an automated testing tool for generated test cases from an existing application programming interface (API) specification.

FIG. 5a illustrates an implementation for using the automated testing tool in a development environment.

FIG. 5b illustrates an implementation for using the automated testing tool in a development pipeline to verify deployment.

FIG. 5c illustrates an implementation for using the automated testing tool in a standalone configuration for obtaining results of a test execution.

FIG. 6 is a screen shot of an example of an output generated by the automated testing tool.

FIG. 7 is a block diagram of an example configuration of an enterprise system.

FIG. 8 is a block diagram of an example configuration of a test device used to test an application build in the application testing environment.

FIG. 9 is a flow chart illustrating example operations that may be performed in automatically generating test cases for APIs.

FIG. 10 is a flow chart illustrating example operations that may be performed in processing sample data in the API specification.

### DETAILED DESCRIPTION

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

When it comes to large and/or complex APIs with many endpoints and attributes, writing test cases manually for boundary testing of APIs can result in ineffective utilization of quality engineering and/or testing teams'efforts and less time to focus on developing test cases for complex functional logic.

Due to lack of such a testing tool, it can make it difficult for continuous integration and consistent testing. Also, from a developer's standpoint, lack of test cases during the development phase inhibits them from performing certain detailed testing prior to handing over the code to a quality engineering team. This clearly demonstrates the need for automatically generating test cases to validate API technical boundaries.

The system described herein improves API testing by enabling development and testing teams to continuously verify the quality, health, and performance of their APIs to deliver a seamless digital experience.

The system is configured to automatically generate non-business test cases based on a predefined structure or schema, such as Open API Specifications (OAS) defined for the API. The OAS is a human and machine-readable interface which defines a standard, programming language-agnostic interface description for hypertext transport protocol (HTTP) APIs. The system provides a tool that takes the OAS document as an input and generates test requests for each API endpoint. The tool analyzes the specification to identify required fields, data types, enumerations, and other constraints, then generates test requests that cover various scenarios, including valid and invalid inputs.

In one aspect, there is provided a system for automated test case generation, the system comprising: a processor; a communication module coupled to the processor; and a memory coupled to the processor, the memory storing computer executable instructions that when executed by the processor cause the system to: obtain an API specification; use the API specification to generate a plurality of test requests, each test request corresponding to an API endpoint associated with an application; generate a plurality of test scenarios based on technical parameters of the API endpoints; and utilize the plurality of test requests and test scenarios in a process associated with the application.

In certain example embodiments, the system is further configured to analyze the API specification to identify attributes of the API.

In certain example embodiments, the attributes of the API comprise at least one of the following: required fields, data types, enumerations, or other constraints.

In certain example embodiments, the system is further configured to obtain sample data included in the API specification; and utilize the sample data to generate the plurality of test requests.

In certain example embodiments, if sample data is unavailable, the system generates values based on a data type or a schema definition.

In certain example embodiments, the process associated with the application corresponds to an application development process, and wherein the test requests and test scenarios verify that the API endpoints are adhering to the API specification while the application is being programmed.

In certain example embodiments, the development process utilizes the system prior to moving to a testing phase.

In certain example embodiments, the process associated with the application corresponds to a testing pipeline, and wherein the test requests and test scenarios verify that API changes or updates do not adversely affect existing functionality.

In certain example embodiments, the test requests and test scenarios are executed along with test cases being applied by a testing team.

In certain example embodiments, the process is associated with the application corresponds to a deployment process that automates API testing during the deployment process to provide responsive feedback on code stability.

In another aspect, there is provided a method for automated test case generation, the method comprising: obtaining an API specification; using the API specification to generate a plurality of test requests, each test request corresponding to an API endpoint associated with an application; generating a plurality of test scenarios based on technical parameters of the API endpoints; and utilizing the plurality of test requests and test scenarios in a process associated with the application.

In certain example embodiments, the method further includes analyzing the API specification to identify attributes of the API.

In certain example embodiments, the attributes of the API comprise at least one of the following: required fields, data types, enumerations, or other constraints.

In certain example embodiments, the method further includes obtaining sample data included in the API specification; and utilizing the sample data to generate the plurality of test requests.

In certain example embodiments, if sample data is unavailable, the method includes generating values based on a data type or a schema definition.

In certain example embodiments, the process associated with the application corresponds to an application development process, and wherein the test requests and test scenarios verify that the API endpoints are adhering to the API specification while the application is being programmed.

In certain example embodiments, the development process utilizes the system prior to moving to a testing phase.

In certain example embodiments, the process associated with the application corresponds to a testing pipeline, and wherein the test requests and test scenarios verify that API changes or updates do not adversely affect existing functionality.

In certain example embodiments, the process associated with the application corresponds to a deployment process that automates API testing during the deployment process to provide responsive feedback on code stability.

In another aspect, there is provided a computer readable medium storing computer-executable instructions for automated test case generation, comprising computer-executable instructions that, when executed by a computing system, cause the system to: obtain an API specification; use the API specification to generate a plurality of test requests, each test request corresponding to an API endpoint associated with an application; generate a plurality of test scenarios based on technical parameters of the API endpoints; and utilize the plurality of test requests and test scenarios in a process associated with the application.

In current processes, API definition adherence, code stability, and system integration is determined after the test cases are defined, whereas in the system described herein, an automated test tool may operate inline or as a standalone module by adhering to the same specifications as the applications accessing the APIs.

The system described herein can include various (i.e., one or more, in various combinations) features, summarized below.
1. Automatic Test Generation: The tool automatically generated test requests for each API endpoint based on the OAS specification.
2. Coverage of Scenarios: The tool can generate test cases for various scenarios such as required fields, data types, enumerations, value restrictions, and more, thereby ensuring comprehensive testing coverage for testing technical boundaries of API.
3. Sample Data Usage: The tool leverages sample data provided in the OAS document as examples for these requests. If sample data is not available, it generates default values based on the data type or schema definition.
4. Customizable Testing: Users can customize test generation options for different endpoints.
5. Integration with Other test frameworks: The tool can generate requests/outputs acceptable by other testing tools like Postman™.

The following benefits may be realized, without limitation:
API Development: Developers can use the tool during API development to ensure that endpoints adhere to the specification and handle all technical and various input scenarios correctly.
QA Testing: QA team can use this tool for regression testing to ensure that API changes or updates does not break existing functionality. They can rely on this tool for technical and non-business data testing.
Continuous Integration/Continuous Deployment (CI/CD): The tool can be integrated into CI/CD pipelines to automate API testing as part of the deployment process, providing immediate feedback on code stability and ensure consistent adherence to API specification.

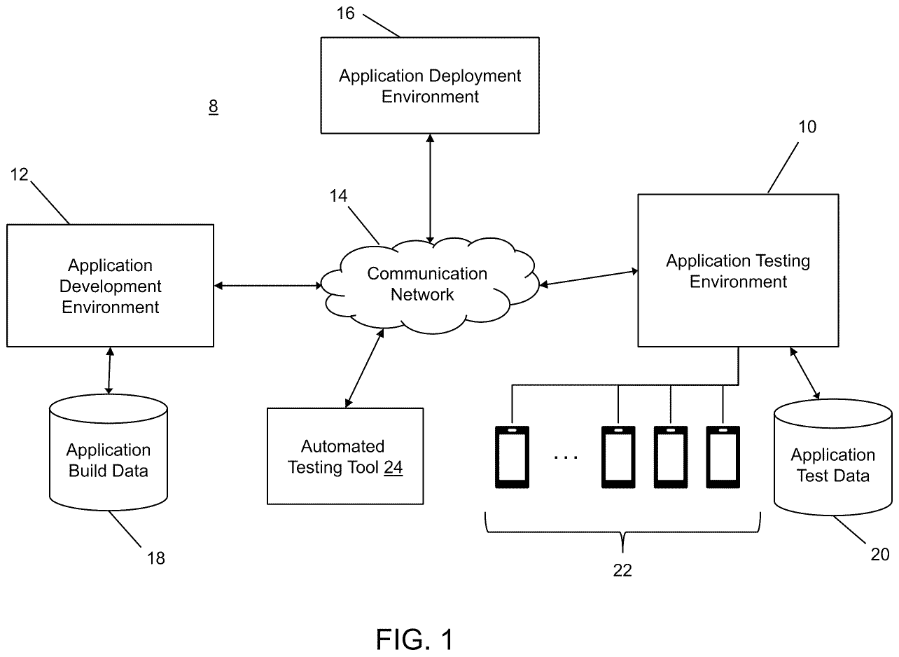

Turning now to the figures, FIG. 1 illustrates an exemplary computing environment 8. In this example, the computing environment 8 may include an application testing environment 10, an application development environment 12, and a communications network 14 connecting one or more components of the computing environment 8. The computing environment 8 may also include or otherwise be connected to an application deployment environment 16, which provides a platform, service, or other entity responsible for posting or providing access to applications that are ready for use by client devices. The application development environment 12 includes or is otherwise coupled to one or more repositories or other data storage elements for storing application build data 18. The application build data 18 can include any computer code and related data and information for an application to be deployed, e.g., for testing, execution or other uses.

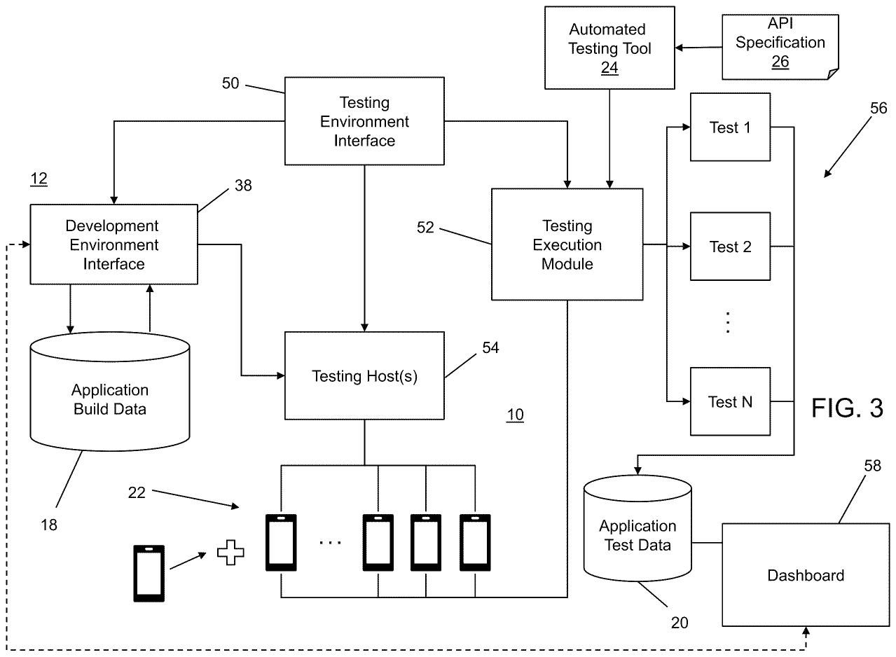

In this example, the application build data 18 can be provided via one or more repositories and include the data and code required to perform application testing on a device or simulator. It can be appreciated that while FIG. 1 illustrates a number of test devices 22 that resemble a mobile communication device, such testing devices 22 can also include simulators, simulation devices or simulation processes, all of which may be collectively referred to herein as “test devices 22” for ease of illustration. The application testing environment 10 may include or otherwise have access to one or more repositories or other data storage elements for storing application test data 20, which includes any files, reports, information, results, metadata or other data associated with and/or generated during a test implemented within the application testing environment 10. As shown in FIG. 1, the application test data 20 can be made available to various entities, e.g., to review, analyze or otherwise consume the results, for example, a dashboard 58 (see FIG. 3-described below).

The computing environment 8 may be part of an enterprise or other organization that both develops and tests applications. The applications may include, integrate or utilize APIs in various ways and, in some implementations, may utilize numerous API endpoints, each of which may require testing. To that end, the computing environment 8 also includes an automated testing tool 24, which may be used as described herein to automatically generate test cases and allow API testing throughout the lifecycle of application development, testing, deployment and ongoing operations.

The communication network 14 may not be required to provide connectivity between the application development environment 12 and the application testing environment 10, wherein such connectivity is provided by an internal network. The application development environment 12 and application testing environment 10 may also be integrated into the same enterprise environment as subsets thereof. That is, the configuration shown in FIG. 1 is illustrative only. Moreover, the computing environment 8 can include multiple enterprises or organizations, e.g., wherein separate organizations are configured to, and responsible for, application testing and application development. For example, an organization may contract a third-party to develop an app for their organization but perform testing internally to meet proprietary or regulatory requirements. Similarly, an organization that develops an app may outsource the testing stages, particularly when testing is performed infrequently. The application deployment environment 16 may likewise be implemented in several different ways. For example, the deployment environment 16 may include an internal deployment channel for employee devices, may include a public marketplace such as an app store, or may include any other channel that can make the app available to clients, consumers or other users.

One example of the computing environment 8 may include a financial institution system (e.g., a commercial bank) that provides financial services accounts to users and processes financial transactions associated with those financial service accounts. Such a financial institution system may provide to its customers various browser-based and mobile applications, e.g., for mobile banking, mobile investing, mortgage management, etc.

Test devices 22 can be, or be simulators for, client communication devices that would normally be associated with one or more users. Users may be referred to herein as customers, clients, correspondents, or other entities that interact with the enterprise or organization associated with the computing environment 8 via one or more apps. Such client communication devices are not shown in FIG. 1 since such devices would typically be used outside of the computing environment 8 in which the development and testing occurs. However, it may be noted that such client communication devices may be connectable to the application deployment environment 16, e.g., to download newly developed apps, to update existing apps, etc. In certain embodiments, a user may operate the client communication devices such that client device performs one or more processes consistent with what is being tested in the disclosed embodiments. For example, the user may use client device to engage and interface with a mobile or web-based banking application which has been developed and tested within the computing environment 8 as herein described. In certain aspects, test devices 22 and client device can include, but are not limited to, a personal computer, a laptop computer, a tablet computer, a notebook computer, a hand-held computer, a personal digital assistant, a portable navigation device, a mobile phone, a wearable device, a gaming device, an embedded device, a smart phone, a virtual reality device, an augmented reality device, third party portals, an automated teller machine (ATM), and any additional or alternate computing device, and may be operable to transmit and receive data across communication networks such as the communication network 14 shown by way of example in FIG. 1.

Communication network 14 may include a telephone network, cellular, and/or data communication network to connect different types of client devices. For example, the communication network 14 may include a private or public switched telephone network (PSTN), mobile network (e.g., code division multiple access (CDMA) network, global system for mobile communications (GSM) network, and/or any 3G, 4G, or 5G wireless carrier network, etc.), Wi-Fi or other similar wireless network, and a private and/or public wide area network (e.g., the Internet).

Referring back to FIG. 1, the computing environment 8 may also include a cryptographic server (not shown) for performing cryptographic operations and providing cryptographic services (e.g., authentication (via digital signatures), data protection (via encryption), etc.) to provide a secure interaction channel and interaction session, etc. Such a cryptographic server can also be configured to communicate and operate with a cryptographic infrastructure, such as a public key infrastructure (PKI), certificate authority (CA), certificate revocation service, signing authority, key server, etc. The cryptographic server and cryptographic infrastructure can be used to protect the various data communications described herein, to secure communication channels therefor, authenticate parties, manage digital certificates for such parties, manage keys (e.g., public and private keys in a PKI), and perform other cryptographic operations that are required or desired for particular applications of the application development environment 12 and/or application testing environment 10. The cryptographic server may be used to protect data within the computing environment 8 (include the application build data 18 and/or application test data 20) by way of encryption for data protection, digital signatures or message digests for data integrity, and by using digital certificates to authenticate the identity of the users and entity devices with which the application development environment 12 and application testing environment 10 communicate to inhibit data breaches by adversaries. It can be appreciated that various cryptographic mechanisms and protocols can be chosen and implemented to suit the constraints and requirements of the particular deployment of the application development environment 12 and application testing environment 10 as is known in the art.

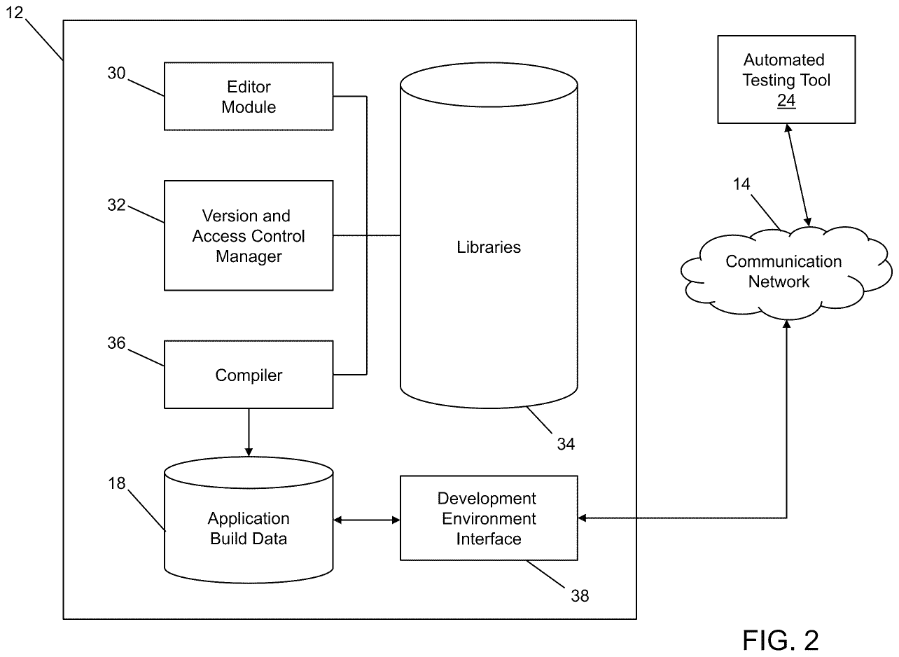

In FIG. 2, an example configuration of the application development environment 12 is shown. It can be appreciated that the configuration shown in FIG. 2 has been simplified for ease of illustration. In certain example embodiments, the application development environment 12 may include an editor module 30, a version and access control manager 32, one or more libraries 34, and a compiler 36, which would be typical components utilized in application development. In this example, the application development environment 12 also includes the application build data 18, which, while shown within the environment 12, may also be a separate entity (e.g., repository) used to store and provide access to the stored build files. The application development environment 12 also includes or is provided with (e.g., via an API or SDK), a development environment interface 38. The development environment interface 38 provides communication and data transfer capabilities between the application development environment 12 and the application testing environment 10 from the perspective of the application development environment 12. As shown in FIG. 2, the development environment interface 38 can connect to the communication network 14 to send/receive data and communications to/from the application testing environment 10 as discussed further below. For example, the testing environment interface 38 can be used to provide test results to the application development environment 12 based on testing conducted in the application testing environment 10.

The editor module 30 can be used by a developer/programmer to create and edit program code associated with an application being developed. This can include interacting with the version and access control manager 32 to control access to current build files and libraries 34 while enforcing permissions and version controls. The compiler 36 may then be used to compile an application build file and other data to be stored with the application build data 18. It can be appreciated that a typical application or software development environment 12 may include other functionality, modules, and systems, details of which are omitted for brevity and ease of illustration. It can also be appreciated that the application development environment 12 may include modules, accounts, and access controls for enabling multiple developers to participate in developing an application, and modules for enabling an application to be developed for multiple platforms. For example, a mobile application may be developed by multiple teams, each team potentially having multiple programmers. Also, each team may be responsible for developing the application on a different platform, such as Apple iOS or Google Android for mobile versions, and Google Chrome or Microsoft Edge for web browser versions. Similarly, applications may be developed for deployment on different device types, even with the same underlying operating system.

By having build files stored for the various operating systems, device types, and versions that are currently compatible and being used, and providing access via the development environment interface 38, the application testing environment 10 can automatically obtain and deploy the latest builds to perform application testing in different scenarios. Such scenarios can include not only different device types, operating systems, and versions, but also the same build under different operating conditions.

While not shown in FIG. 2 for clarity of illustration, in example embodiments, the application development environment 12 may be implemented using one or more computing devices such as terminals, servers, and/or databases, having one or more processors, communications modules, and database interfaces. Such communications modules may include the development environment interface 38, which enables the application development environment 12 to communicate with one or more other components of the computing environment 8, such as the application testing environment 10, via a bus or other communication network, such as the communication network 14. While not delineated in FIG. 2, the application development environment 12 (and any of its devices, servers, databases, etc.) includes at least one memory or memory device that can include a tangible and non-transitory computer-readable medium having stored therein computer programs, sets of instructions, code, or data to be executed by the one or more processors. FIG. 2 illustrates examples of modules, tools and engines stored in memory within the application development environment 12. It can be appreciated that any of the modules, tools, and engines shown in FIG. 2 may also be hosted externally and be available to the application development environment 12, e.g., via communications modules such as the development environment interface 38.

As illustrated in FIG. 2, the application development environment 12 may include or have access to (e.g., via communication network 14) the automated testing tool 24, which enables application developers to test the integrity of APIs utilized by an application or system.

Turning now to FIG. 3, an example configuration of the application testing environment 10 is shown. The application testing environment 10 includes a testing environment interface 50, which is coupled to the development environment interface 38 in the application development environment 12, a testing execution module 52, and one or more testing hosts 54. The testing environment interface 50 can provide a UI for personnel or administrators in the application testing environment 10 to coordinate an automated build management process as herein described and to initiate or manage a test execution process as herein described.

The testing environment interface 50 can instruct the development environment interface 38, e.g., by sending a message or command via the communication network 14, to access the application build data 18 to obtain the latest application build(s) based on the number and types of devices being tested by the testing host(s) 54. The latest application builds are then returned to the application testing environment 10 by the development environment interface 38 to execute an automated build retrieval operation. As shown in FIG. 3, the application build data 18 can be sent directly to the testing host(s) 54 and thus the testing host(s) 54 can also be coupled to the communication network 14. It can be appreciated that the application build data 18 can also be provided to the testing host(s) 54 via the testing environment interface 50. The host(s) 54 in this example have access to a number of test devices 22 which, as discussed above, can be actual devices or simulators for certain devices. The testing host(s) 54 are also scalable, allowing for additional test devices 22 to be incorporated into the application testing environment 10. For example, a new test device 22 may be added when a new device type is released and will be capable of using the application being tested. Upon installation, the application on each test device 22 can be configured to point to the appropriate environment under test and other settings can be selected/deselected.

The test devices 22 are also coupled to the testing execution module 52 to allow the testing execution module 52 to coordinate tests 56 to evaluate metrics, for example, by executing tests for application traffic monitoring, determining UI response times, examining device logs, and determining resource utilization metrics (with Test 1, Test 2, . . . , Test N; shown generally in FIG. 3 for illustrative purposes). The tests 56 can generate data logs, reports and other outputs, stored as application test data 20, which can be made available to various entities or components, such as the dashboard 58. The framework shown in FIG. 3 enables the application testing environment 10 to download the latest builds from the respective repositories for the respective device/OS platform(s) and run a UI flow on all test devices 22 to configure the environment, disable system pop-ups, and set feature flags. In this way, the framework can automate the build download and installation process. The framework illustrated in FIG. 3 can include customized app testing tools that leverage the existing application testing tool 57 by using device logs or session details to estimate lag times that would normally be inaccurately included in the testing results.

It can be appreciated that while the testing environment interface 50, the testing host(s) 54, and the testing execution module 52 are shown as separate modules in FIG. 3, such modules may be combined in other configurations and thus the delineations shown in FIG. 3 are for illustrative purposes.

FIG. 3 also illustrates that the automated testing tool 24 may be integrated with or otherwise be accessible to the application testing environment 10. The tool 24 may obtain API specifications 26, which have a predefined structure or schema, to enable automated test case generation. In this way, API testing can be automated and implemented in the environment 10, by creating new tests 56 associated with the API endpoints.

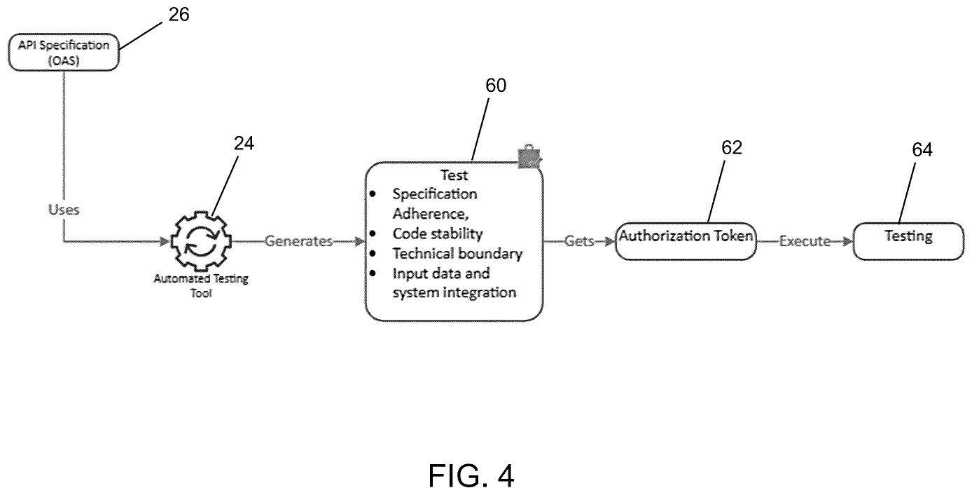

Referring now to FIG. 4, a workflow that utilizes the automated testing tool 24 is shown. In this example, the tool 24 obtains an API specification 26, e.g., of the OAS format, which is input to the tool 24 to enable the tool 24 to generate test parameters 60, such as test specification and adherence, code stability, technical boundaries, input data, and system integration, among other things. The automated testing tool 24 relies on the predefined structure of the API specification 26 to determine which fields and parameters to look for and what expected interactions, inputs, and outputs occur at the technical boundaries of the API. The test parameters 60 enable the automated testing tool 24 to get an authorization token 62 to enable a testing process 64 to be executed.

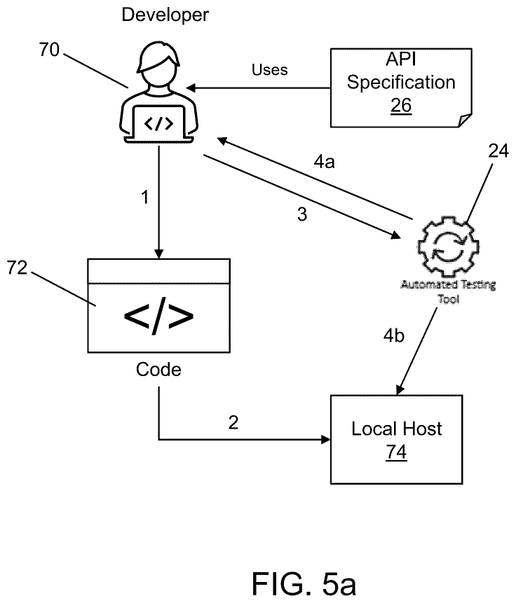

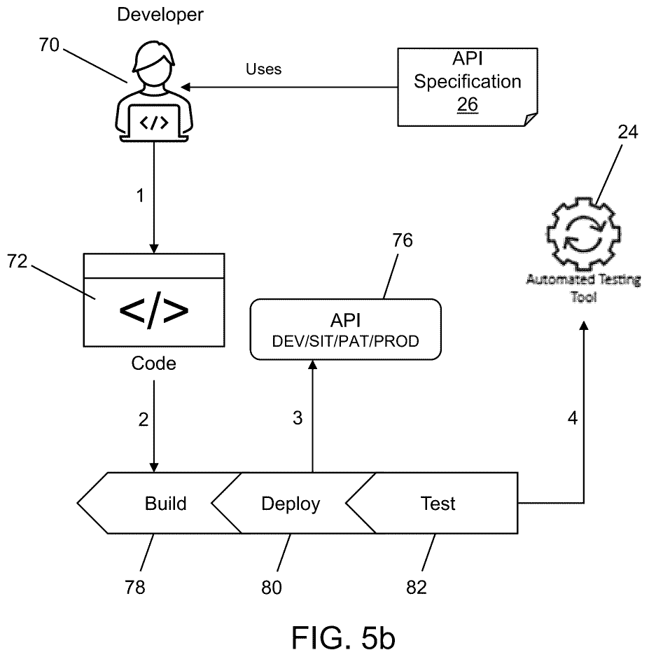

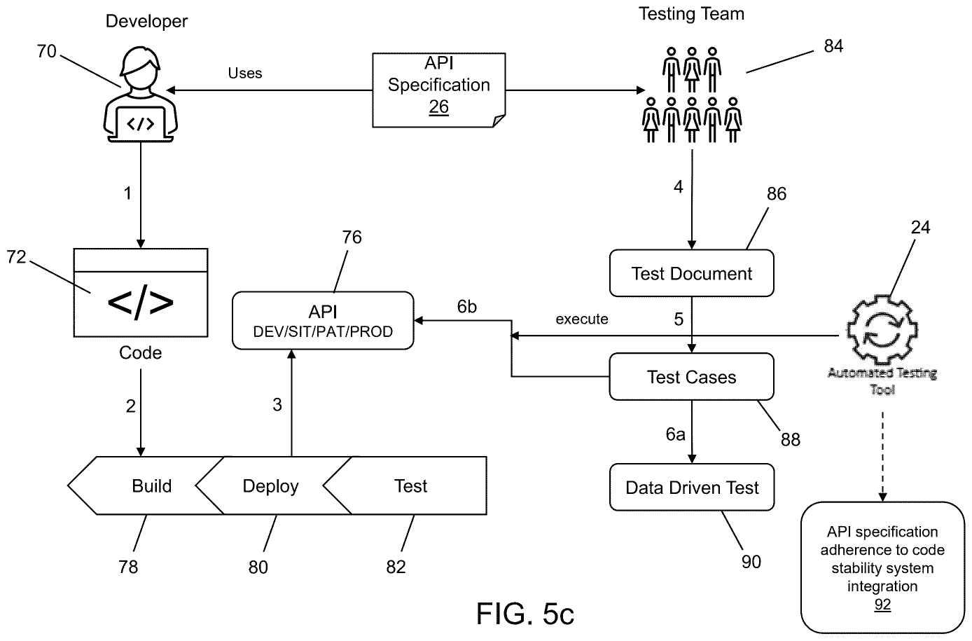

Referring to FIGS. 5a, 5b, and 5c, the automated testing tool 24 is shown in different configurations and scenarios to illustrates its versatility within the application and API ecosystem. In FIG. 5a, the automated testing tool 24 is utilized by a developer 70. The developer 70 uses the API specification 26 while creating code 72 at step 1, that is being presented on/to a local host 74 at step 2. The API specification 26 is used at step 3 by interfacing with the automated testing tool 24. The automated testing tool 24 generates the test cases to allow the developer 70 to test their code 72 inline to ensure that as code is created, any implications on the technical boundaries of the API are adhered to. This inline testing allows errors to be caught and corrected before the testing or dev/ops phases. That is, as shown in FIG. 5a, the automated testing tool 24 can be used “inline” by developers such that code being deployed on a local host 74 can be checked by the tool 24 during development rather than waiting for the testing phase.

In FIG. 5b, the automated testing tool 24 is utilized by a developer 70 in a DevOps pipeline, to verify deployment. As above, the API specification 26 is used to verify code 72 that is being compiled into a build 78, being deployed 80 and thus interacting with the API 76 and tested 82. In this scenario, DevOps can integrate the tool 24 with their pipeline to verify a deployment while it is being deployed. Since the automated testing tool 24 can automatically generate test cases based on the OAS, testing data can continuously be gathered.

FIG. 5c illustrates the automated testing tool 24 being used as a standalone tool by the testing team 84 to get results of test executions. That is, the testing team 84 can use the automated testing tool 24 as a standalone module to get the results of test executions. The testing tool 24 uses the API specification 26 (e.g., OAS) to adhere to code stability system integration. When the testing team generates a test document 86 and test cases 88 to generate data driven tests 90, the automated testing tool 24, which has generated at least some test cases for the API 76, can enforce API specification adherence to code stability and system integration at 92. As shown in FIG. 5c, the automated testing tool 24 executes based on the test cases 88 at step 6b, to automatically determine adherence without disrupting the existing testing pipeline, providing a standalone operation.

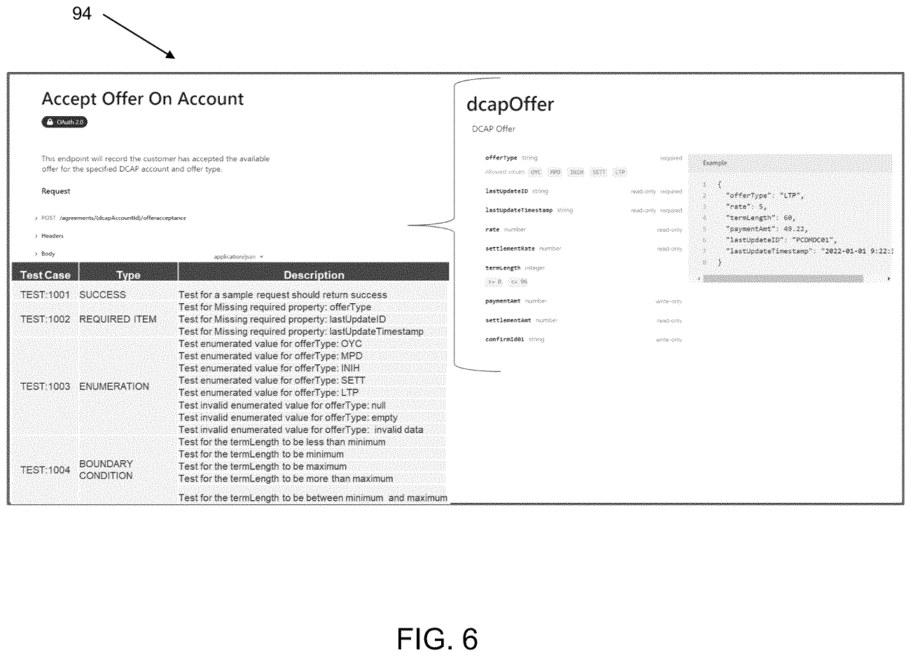

FIG. 6 illustrates an output that may be generated by the automated testing tool 24, in this example for calling an API endpoint used to record that a user has accepted an offer for an account type. The process and output may equally apply to any API endpoint functionality.

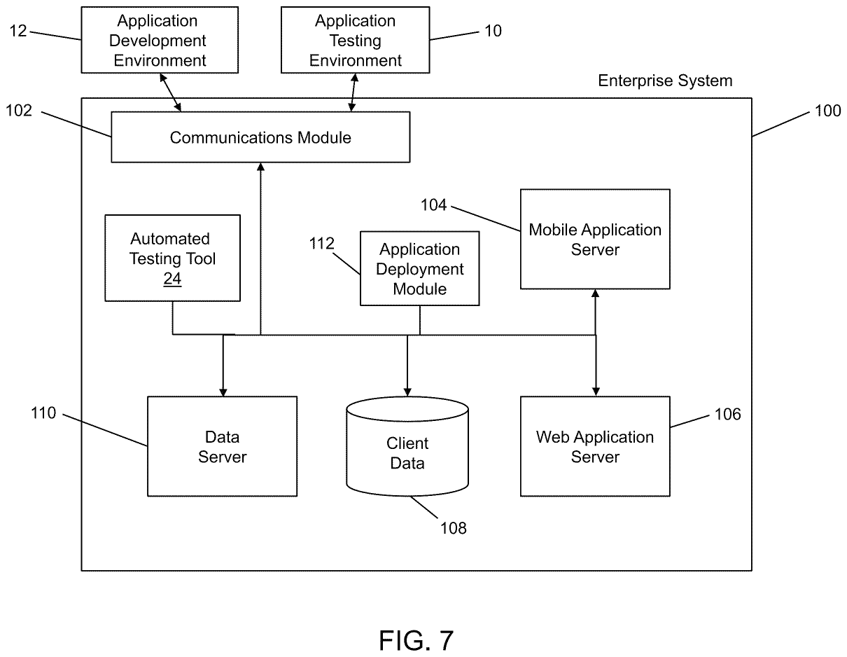

In FIG. 7, an example configuration of an enterprise system 100 is shown. The enterprise system 100 includes a communications module 102 that enables the enterprise system 100 to communicate with one or more other components of the computing environment 8, such as the application testing environment 10 or application development environment 12, via a bus or other communication network, such as the communication network 14. While not delineated in FIG. 7, the enterprise system 100 includes at least one memory or memory device that can include a tangible and non-transitory computer-readable medium having stored therein computer programs, sets of instructions, code, or data to be executed by one or more processors (not shown for clarity of illustration). FIG. 7 illustrates examples of servers and datastores/databases operable within the enterprise system 100. It can be appreciated that any of the components shown in FIG. 7 may also be hosted externally and be available to the enterprise system 100, e.g., via the communications module 102. In the example embodiment shown in FIG. 7, the enterprise system 100 includes one or more servers to provide access to client data 108, e.g., for development or testing purposes. Exemplary servers include a mobile application server 104, a web application server 106 and a data server 110. Although not shown in FIG. 7, as noted above, the enterprise system 100 may also include a cryptographic server for performing cryptographic operations and providing cryptographic services. The cryptographic server can also be configured to communicate and operate with a cryptographic infrastructure. The enterprise system 100 may also include one or more data storage elements for storing and providing data for use in such services, such as data storage for storing client data 108.

Mobile application server 104 supports interactions with a mobile application installed on client device (which may be similar or the same as a test device 22). Mobile application server 104 can access other resources of the enterprise system 100 to carry out requests made by, and to provide content and data to, a mobile application on client device. In certain example embodiments, mobile application server 104 supports a mobile banking application to provide payments from one or more accounts of user, among other things.

Web application server 106 supports interactions using a website accessed by a web browser application running on the client device. It can be appreciated that the mobile application server 104 and the web application server 106 can provide different front ends for the same application, that is, the mobile (app) and web (browser) versions of the same application. For example, the enterprise system 100 may provide a banking application that be accessed via a smartphone or tablet app while also being accessible via a browser on any browser-enabled device.

The client data 108 can include, in an example embodiment, financial data that is associated with users of the client devices (e.g., customers of the financial institution). The financial data may include any data related to or derived from financial values or metrics associated with customers of a financial institution system (i.e., the enterprise system 100 in this example), for example, account balances, transaction histories, line of credit available, credit scores, mortgage balances, affordability metrics, investment account balances, investment values and types, among many others. Other metrics can be associated with the financial data, such as financial health data that is indicative of the financial health of the users of the client devices.

An application deployment module 112 is also shown in the example configuration of FIG. 7 to illustrate that the enterprise system 100 can provide its own mechanism to deploy the developed and tested applications onto client devices within the enterprise. It can be appreciated that the application deployment module 112 can be utilized in conjunction with a third-party deployment environment 16 such as an app store to have tested applications deployed to employees and customers/clients. The automated testing tool 24 may also be integrated into or otherwise provided by the enterprise system 100 as shown in FIG. 7.

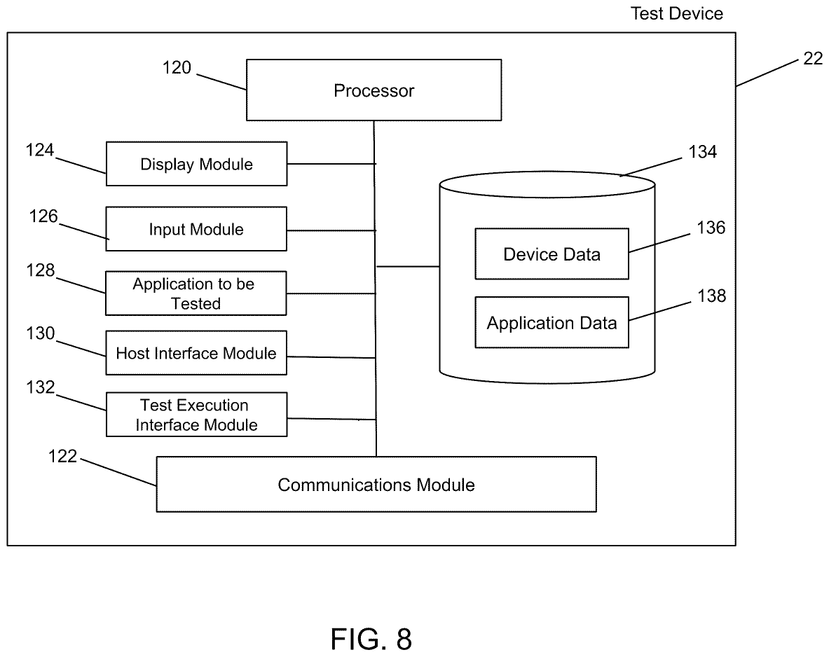

In FIG. 8, an example configuration of a test device 22 is shown. It can be appreciated that the test device 22 shown in FIG. 8 can correspond to an actual device or represent a simulation of such a device 22. In certain embodiments, the test device 22 may include one or more processors 120, a communications module 122, and a data store 134 storing device data 136 and application data 138. Communications module 122 enables the test device 22 to communicate with one or more other components of the computing environment 8 via a bus or other communication network, such as the communication network 14. While not delineated in FIG. 8, the client device 22 includes at least one memory or memory device that can include a tangible and non-transitory computer-readable medium having stored therein computer programs, sets of instructions, code, or data to be executed by processor 120. FIG. 8 illustrates examples of modules and applications stored in memory on the test device 22 and operated by the processor 120. It can be appreciated that any of the modules and applications shown in FIG. 8 may also be hosted externally and be available to the test device 22, e.g., via the communications module 122.

In the example embodiment shown in FIG. 8, the test device 22 includes a display module 124 for rendering GUIs and other visual outputs on a display device such as a display screen, and an input module 126 for processing user or other inputs received at the test device 22, e.g., via a touchscreen, input button, transceiver, microphone, keyboard, etc. The test device 22 may also include an application 128 to be tested that includes the latest application build data 18 to be tested using the test device 22, e.g., by executing tests 56. The test device 22 may include a host interface module 130 to enable the test device 22 to interface with a testing host 54 for loading an application build. The test device 22 in this example embodiment also includes a test execution interface module 132 for interfacing the application 128 with the testing execution module 52. The data store 134 may be used to store device data 136, such as, but not limited to, an IP address or a MAC address that uniquely identifies test device 22. The data store 134 may also be used to store application data 138, such as, but not limited to, login credentials, user preferences, cryptographic data (e.g., cryptographic keys), etc.

It will be appreciated that only certain modules, applications, tools and engines are shown in FIGS. 2 to 4 and 6 to 7 for ease of illustration and various other components would be provided and utilized by the application testing environment 10, application development environment 12, and test device 22, as is known in the art.

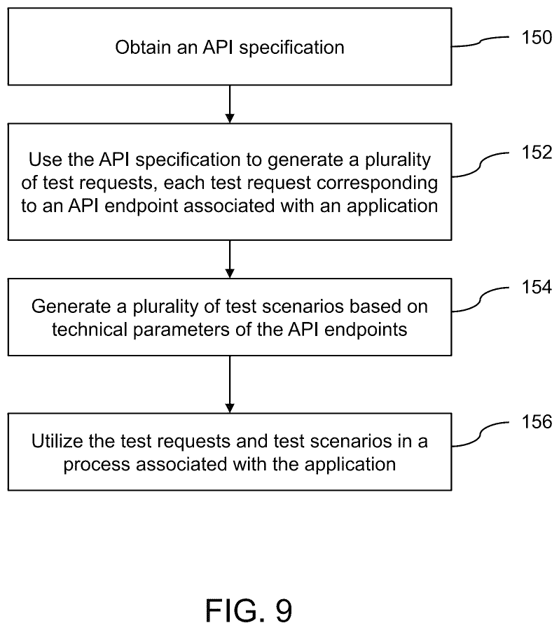

Referring now to FIG. 9, a flow chart is provided that illustrates example operations that may be performed in automatically generating test cases for APIs.

At block 150, the automated testing tool 24 obtains the API specification 26. At block 152, the automated testing tool 24 uses the API specification 26 to generate multiple test requests. Each of the test requests corresponds to an API endpoint, enabling the tool 24 to deal with complex applications with APIs 76 that have many endpoints and endpoint types. At block 154, the automated testing tool 24 generates multiple test scenarios based on technical parameters of the API endpoints. These technical parameters can be obtained by parsing the API specification 26, which has a predefined structure or schema that is machine readable, e.g., OAS. At bock 156, the test requests and the test scenarios are utilized in a process associated with the application, for example, development, deployment, and testing as shown in FIGS. 5a-5c.

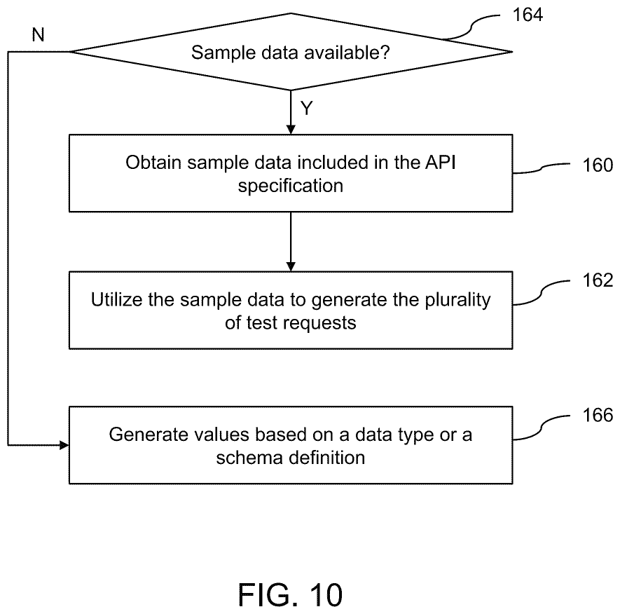

FIG. 10 provides a flow chart that illustrates example operations that may be performed in processing sample data in the API specification 26. At block 160, the automated testing tool 24 obtains sample data included in the API specification 26. Then, at block 162, the automated testing tool 24 utilizes the sample data to generate the plurality of test requests, e.g., by using the sample data to determine what parameters or constraints the tool 24 should be looking for to adhere to API endpoint functional boundaries.

At block 164, the automated testing tool 24 may determine if sample data is available. If not, at block 166, the automated testing tool 24 generates values based on a data type or a schema definition that can be read from the structure of the API specification 26.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as transitory or non-transitory storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory computer readable medium which can be used to store the desired information, and which can be accessed by an application, module, or both. Any such computer storage media may be part of the computing environment 8, any component of or related thereto, etc., or accessible or connectable thereto. Any application or module herein described may be implemented using computer readable/executable instructions that may be stored or otherwise held by such computer readable media.

The steps or operations in the flow charts and diagrams described herein are provided by way of example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as having regard to the appended claims in view of the specification as a whole.

1. A system for automated test case generation, the system comprising:
a processor;
a communication module coupled to the processor; and
a memory coupled to the processor, the memory storing computer executable instructions that when executed by the processor cause the system to:
obtain an application programming interface (API) specification;
use the API specification to generate a plurality of test requests, each test request corresponding to an API endpoint associated with an application;
generate a plurality of test scenarios based on technical parameters of the API endpoints; and
utilize the plurality of test requests and test scenarios in a process associated with the application.

2. The system of claim 1, further comprising computer executable instructions that when executed by the processor cause the system to:
analyze the API specification to identify attributes of the API.

3. The system of claim 2, wherein the attributes of the API comprise at least one of the following: required fields, data types, enumerations, or other constraints.

4. The system of claim 1, further comprising computer executable instructions that when executed by the processor cause the system to:
obtain sample data included in the API specification; and
utilize the sample data to generate the plurality of test requests.

5. The system of claim 4, wherein if sample data is unavailable, the system generates values based on a data type or a schema definition.

6. The system of claim 1, wherein the process associated with the application corresponds to an application development process, and wherein the test requests and test scenarios verify that the API endpoints are adhering to the API specification while the application is being programmed.

7. The system of claim 6, wherein the development process utilizes the system prior to moving to a testing phase.

8. The system of claim 1, wherein the process associated with the application corresponds to a testing pipeline, and wherein the test requests and test scenarios verify that API changes or updates do not adversely affect existing functionality.

9. The system of claim 8, wherein the test requests and test scenarios are executed along with test cases being applied by a testing team.

10. The system of claim 1, wherein the process is associated with the application corresponds to a deployment process that automates API testing during the deployment process to provide responsive feedback on code stability.

11. A method for automated test case generation, the method comprising:
obtaining an application programming interface (API) specification;
using the API specification to generate a plurality of test requests, each test request corresponding to an API endpoint associated with an application;
generating a plurality of test scenarios based on technical parameters of the API endpoints; and
utilizing the plurality of test requests and test scenarios in a process associated with the application.

12. The method of claim 11, further comprising:
analyzing the API specification to identify attributes of the API.

13. The method of claim 12, wherein the attributes of the API comprise at least one of the following: required fields, data types, enumerations, or other constraints.

14. The method of claim 11, further comprising:
obtaining sample data included in the API specification; and
utilizing the sample data to generate the plurality of test requests.

15. The method of claim 14, wherein if sample data is unavailable, the method comprises generating values based on a data type or a schema definition.

16. The method of claim 11, wherein the process associated with the application corresponds to an application development process, and wherein the test requests and test scenarios verify that the API endpoints are adhering to the API specification while the application is being programmed.

17. The method of claim 16, wherein the development process utilizes the system prior to moving to a testing phase.

18. The method of claim 11, wherein the process associated with the application corresponds to a testing pipeline, and wherein the test requests and test scenarios verify that API changes or updates do not adversely affect existing functionality.

19. The method of claim 11, wherein the process is associated with the application corresponds to a deployment process that automates API testing during the deployment process to provide responsive feedback on code stability.

20. A non-transitory computer readable medium storing computer-executable instructions for automated test case generation, comprising computer-executable instructions that, when executed by a computing system, cause the system to:
obtain an application programming interface (API) specification;
use the API specification to generate a plurality of test requests, each test request corresponding to an API endpoint associated with an application;
generate a plurality of test scenarios based on technical parameters of the API endpoints; and
utilize the plurality of test requests and test scenarios in a process associated with the application.
